(19) United States
(12) Patent Application Publication
(10) Pub. No.: US 2026/0183585 A1
(43) Pub. Date: Jul. 2, 2026

(54) AUTOMATIC FIRE BLANKET COVERING DEVICE FOR BURNING LITHIUM BATTERY OF ELECTRIC VEHICLE

(71) Applicant: Taiwan Intelligent Robotics Company, Ltd., Taipei City (TW)

(72) Inventors: KUO-TSUNG HUANG, Taipei City (TW); YEN-CHU LAI, Taipei City (TW); SHIN-BIN KO, Taipei City (TW); YEN-HUNG LAI, Taipei City (TW)

(21) Appl. No.: 19/097,924

(22) Filed: Apr. 2, 2025

(30) Foreign Application Priority Data
Dec. 30, 2024 (TW) 113151508

(51) Int. Cl. A62C 8/06; A62C 3/07; A62C 3/16; A62C 37/40

(52) U.S. Cl. CPC A62C 8/06; A62C 3/07; A62C 3/16; A62C 37/40

(57) ABSTRACT

The present invention provides an automatic fire blanket covering device for a burning lithium battery of an electric vehicle, including a fire blanket box, a fire blanket and at least one pneumatic device, where the fire blanket box includes a fire blanket magazine, and further includes a control unit; the fire blanket is arranged on the fire blanket magazine; and the pneumatic device is arranged on the fire blanket box and coupled to four corners of the fire blanket, and the pneumatic device is in signal connection with the control unit. If the electric vehicle catches fire, the pneumatic device immediately ejects the fire blanket towards four corners of a parking space where the electric vehicle is parked or four corners of the body of the electric vehicle, so that the fire blanket covers the whole body of the electric vehicle, and the contact between the electric vehicle and the air is blocked, thereby extinguishing the fire of the electric vehicle. The starting mechanism of the present invention is triggered by sensing or an upper system, so that the fire blanket can cover the fire blanket on a burning vehicle in time and immediately.

### REFERENCE TO RELATED APPLICATIONS

The present application is based on, and claims priority from, Taiwan application number 113151508, filed 2024/Dec./30, the disclosure of which is hereby incorporated by reference herein in its entirety.

### BACKGROUND OF THE INVENTION

### Field of the Invention

The present invention relates to an automatic fire blanket covering device for a burning lithium battery of an electric vehicle, and in particular to a fire blanket covering device capable of being mounted inside a building and extinguishing an electric vehicle on fire.

### Description of the Prior Art

With the rise of green energy, various kinds of energy-saving and carbon-reducing commodities have emerged, among which electric vehicles can serve as representative products.

The electric vehicle includes a lithium battery pack, a vehicle body, an electronic device, a motor and the like. The lithium battery pack provides electric energy to the motor and the electronic device to enable the electric vehicle to run, so the lithium battery is the most important thing for the electric vehicle.

However, most of the accidents of the electric vehicle are caused by fire, mainly caused by lithium battery fire. Furthermore, the lithium battery fire is increasing year by year. The causes of the electric vehicle fire are nothing more than external force collusion, product quality, overheating of the lithium battery, overcharge and the like.

The challenges that electric vehicles may face when catching fire inside buildings include: The fire blanket cannot be unfolded, toxic firefighting water pollutes the environment, a special chemical fire extinguisher is required, toxic smoke and high temperature are inaccessible, it is difficult to extinguish and personal injury is caused, and the fire spreads to the upper floors of the building and to adjacent vehicles.

In conclusion, at present, there is still no effective way to overcome the challenges of electric vehicles catching fire inside buildings, so how to effectively extinguish electric vehicle fires within buildings has become an urgent and innovative project in the industry.

### SUMMARY OF THE INVENTION

In view of the shortcomings of the prior art, there is a pressing need for improvement and innovation. After years of research and experimentation, an automatic fire blanket covering device for a burning lithium battery of an electric vehicle of the present invention has been successfully developed.

The present invention provides an automatic fire blanket covering device for a burning lithium battery of an electric vehicle, including a fire blanket box, a fire blanket and at least one pneumatic device, where the fire blanket box includes a fire blanket magazine, and further includes a control unit; the fire blanket is arranged on the fire blanket magazine; and the pneumatic device is arranged on the fire blanket box and coupled to four corners of the fire blanket, and the pneumatic device is in signal connection with the control unit.

In one embodiment, the fire blanket box includes a first door panel, a second door panel and a bottom plate; the first door panel is pivoted to one side of the fire blanket box; the second door panel is pivoted to the other side of the fire blanket box; and the bottom plate is slidingly arranged at the bottom end of the fire blanket box, and the fire blanket covers the bottom plate.

In one embodiment, the automatic fire blanket covering device for the burning lithium battery of the electric vehicle further includes a driving device, where the driving device is arranged on the fire blanket box and is in signal connection with the control unit, and the driving device is coupled to the first door panel and the second door panel.

In one embodiment, the fire blanket box further includes a switch, a socket, a safe lock and a caution light, and the control unit is in signal connection with the switch, the socket, the safe lock and the caution light.

In one embodiment, one side of the fire blanket located outside the fire blanket box has a pattern.

In one embodiment, the automatic fire blanket covering device for the burning lithium battery of the electric vehicle further includes at least one sensor, where the sensor is in signal connection with the control unit; and the sensor is a smoke detector, an image detection device or a thermal imaging sensing device.

In one embodiment, the fire blanket box includes a plurality of fixed strips and a plurality of dampers, where the fixed strips are arranged at the corners of the fire blanket box; and the dampers are arranged at free ends of the fixed strips.

In conclusion, the automatic fire blanket covering device for the burning lithium battery of the electric vehicle provided by the present invention uses the sensor to sense whether the electric vehicle below has a sign of fire. If the electric vehicle catches fire, the pneumatic device immediately ejects the fire blanket towards four corners of a parking space where the electric vehicle is parked or four corners of the body of the electric vehicle, so that the fire blanket covers the whole body of the electric vehicle, and the contact between the electric vehicle and the air is blocked, thereby extinguishing the fire of the electric vehicle.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 is a schematic diagram of an automatic fire blanket covering device for a burning lithium battery according to the present invention;

FIG. 2 is another schematic diagram of an automatic fire blanket covering device for a burning lithium battery according to the present invention;

FIG. 3 is a schematic diagram of folding of a wide side of a fire blanket;

FIG. 4 is a schematic diagram of folding of a long side of a fire blanket; and

FIG. 5 is a schematic diagram of a fire blanket of the present invention covering an electric vehicle.

### DETAILED DESCRIPTION OF THE INVENTION

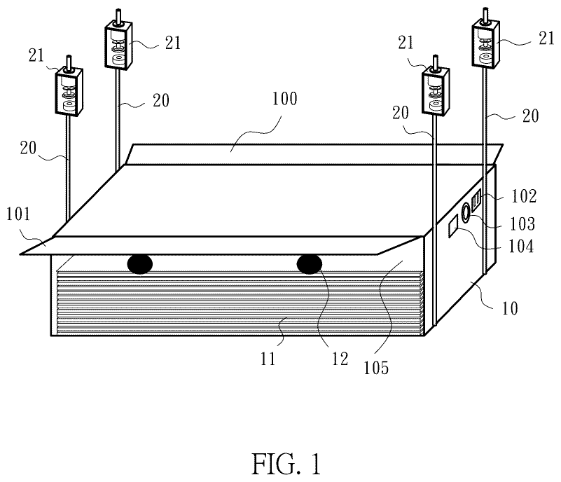

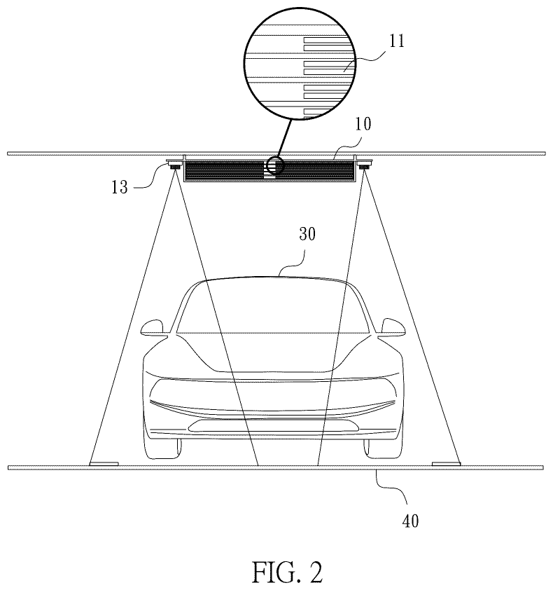

Refer to FIG. 1 and FIG. 2. FIG. 1 is a schematic diagram of an automatic fire blanket covering device for a burning lithium battery according to the present invention. FIG. 2 is another schematic diagram of an automatic fire blanket covering device for a burning lithium battery according to the present invention. As shown in the figure, the present invention provides an automatic fire blanket covering device for a burning lithium battery of an electric vehicle, including a fire blanket box 10, a fire blanket 11, a plurality of pneumatic devices 12 and at least one sensor 13.

The fire blanket box 10 includes a first door panel 100, a second door panel 101, a switch (not shown in the figure), a socket 102, a safe lock 103, a caution light 104, a bottom plate (not shown in the figure) and a control unit (not shown in the figure).

A fire blanket magazine 105 is arranged inside the fire blanket box 10. The first door panel 100 and the second door panel 101 are pivoted to two sides of the fire blanket box 10. At least one driving device (not shown in the figure) is arranged outside the fire blanket magazine 105 or the fire blanket box 10, the driving device is coupled to the first door panel 100 and the second door panel 101, and the driving device drives the first door panel 100 and the second door panel 101 to strut the first door panel 100 and the second door panel 101.

The switch, the socket 102, the safe lock 103 and the caution light 104 are arranged on one side of the fire blanket box 10. The bottom plate is slidingly arranged at the bottom end of the fire blanket box 10. The control unit is arranged on the fire blanket box 10, and the control unit is connected to the switch, the socket 102, the safe lock 103 and the caution light 104. The bottom plate is slidingly arranged at the bottom of the fire blanket box 10. Furthermore, two guide rails (not shown in the figure) are arranged at the bottom of the fire blanket box 10, and the bottom plate is slidingly arranged at the bottom end of the fire blanket box 10.

The fire blanket box 10 further includes a plurality of fixed strips 20 and a plurality of dampers 21, the fixed strips 20 are toothed strips, the fixed strips 20 are arranged at four corners of the fire blanket box 10, and the dampers 21 are arranged at one end of each of the fixed strips 20 away from the fire blanket box 10.

After being folded, the fire blanket 11 covers the bottom plate and is arranged in the fire blanket magazine 105. The pneumatic device 12 is coupled to four corners of the fire blanket 11, and the pneumatic device 12 is arranged inside the fire blanket box 10 and is in signal connection with the control unit. The air pressure ratio of the pneumatic device 12 will be filled with a corresponding pressure value according to a mounting height.

One of the characteristics of the present invention is: the pneumatic device 12 can use a rubber bullet, the folded fire blanket 11 is arranged inside the fire blanket box 10 in a multi-layer stacking manner, and the rubber bullet is located at the top end of the folded fire blanket 11. After the pneumatic device 12 ejects the rubber bullet, the rubber bullet drives different layers of fire blankets 11 and sequentially throws out the fire blankets (the length of the fire blanket 11 and the increased weight are gradually taken out, and each layer of fire blanket 11 is gradually pulled out by the gravity), so that a pneumatic power source is not too large at first, and the system or device can be simplified.

The pneumatic device 12 of the present invention uses a pneumatic power source as a throwing power source of the fire blanket 11, so the output magnitude of the pneumatic source can be set. For example, the rubber bullets with different weights or shapes are thrown, or the length or pipe diameter of a gun barrel of the pneumatic device 12 is adjusted, thereby causing kinetic energy difference. The pneumatic device 12 can be suitable for various specifications (different weights or lengths and widths) of fire blankets 11.

In one embodiment, the pneumatic power source can set the output magnitude of the pneumatic source, for example, throwing different distances to be suitable for the vehicle length and vehicle width of different parking spaces (or vehicle lengths/models).

In one embodiment, the pneumatic source of the present invention can set the output direction of the pneumatic source, for example, the angle of the gun barrel, throwing different angles to be suitable for the vehicle length and vehicle width of different parking spaces (or vehicle lengths/models).

In one embodiment, the pneumatic power source of the present invention can set the output magnitude and the output direction of the pneumatic source at the same time, for example, throwing different distances or angles to determine the mounting height of a ceiling of the fire blanket box 10 to be suitable for different floor heights.

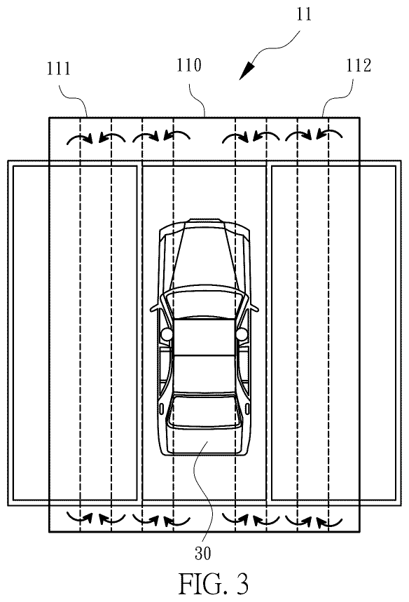

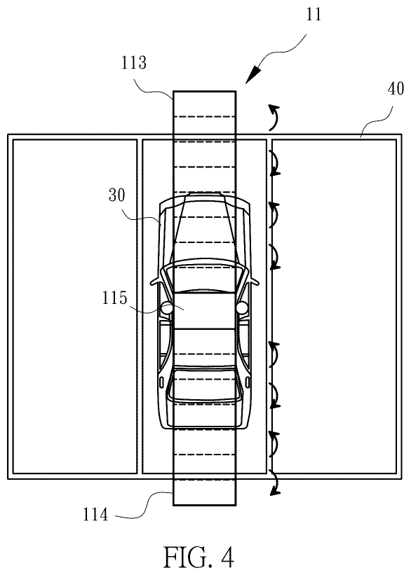

Refer to FIG. 3 and FIG. 4. FIG. 3 is a schematic diagram of folding of a wide side of a fire blanket. FIG. 4 is a schematic diagram of folding of a long side of a fire blanket. As shown in the figure, the folding manner of the fire blanket 11 is: for example, the fire blanket 11 has the width of 600 cm and the length of 800 cm, the wide side of the fire blanket 11 is folded, and the long side of the fire blanket 11 is folded.

The wide side folding (transverse folding) manner is: the wide side of the fire blanket 11 is divided into a first block 111, a wide central block 110 and a second block 112, the first block 111 and the second block 112 are respectively divided into a plurality of areas equidistantly, and the areas located on two sides of the fire blanket 11 are sequentially folded toward the wide central block 110.

The long side folding (longitudinal folding) manner is: the long side of the fire blanket 11 with the folded wide side is divided into a third block 113, a long central block 115 and a fourth block 114, the third block 113 and the fourth block 114 are respectively divided into a plurality of areas equidistantly, and the areas located at two ends of the fire blanket 11 are sequentially folded towards the long central block 115. One side of the fire blanket 11 located outside the fire blanket box 10 has a pattern (not shown in the figure).

One of the characteristics of the present invention is: the folded (longitudinally folded or long-side folded) fire blanket 11 bypasses a part below the bottom plate, so that when the fire blanket 11 is separated from (ejects) the fire blanket box 10, the fire blanket can be completely separated from the fire blanket box 10.

The sensor 13 is a smoke detector, an image detection device or a thermal imaging sensing device, and the sensor 13 is in signal connection with the control unit. The control unit has the function of storing electricity, so during power failure, the control unit can provide electric energy to the sensor 13, the caution light 104, the socket 102, the pneumatic device 12 or the safe lock 103. In addition, the fire blanket box 10 can further include a storage battery (not shown in the figure). During power failure, the storage battery can provide electric energy to the control unit, the sensor 13, the caution light 104, the socket 102, the pneumatic device 12 or the safe lock 103.

As shown in FIG. 2, the automatic fire blanket covering device for the burning lithium battery of the electric vehicle provided by the present invention is arranged inside the building through hanging and located above the electric vehicle 30, and the electric vehicle 30 is located at a parking space 40. Furthermore, one end of the fire blanket box 10 with the dampers 21 is fixed on a ceiling fixed inside the building (an indoor parking lot or parking space 40), and located above the electric vehicle 30. The fixed strips 20 can adjust the distance of the fire blanket box 10 relative to the electric vehicle. The pattern of the fire blanket box 10 can be used for a worker for mounting the automatic fire blanket covering device for the burning lithium battery of the electric vehicle to identify the ejecting direction or mounting direction of the fire blanket 11, and can have the function of trademark, advertisement, mark and direction identification. When the safe lock 103 is in a locked state, the automatic fire blanket covering device for the burning lithium battery of the electric vehicle can be separated from action protection during movement, maintenance or mounting; and after the safe lock is unlocked, the automatic fire blanket covering device for the burning lithium battery of the electric vehicle can act. The control unit may adopt remote control. The remote control of the control unit can use an upper system, such as a central control system of the building, control of a handheld communication device and a remote controller.

The automatic fire blanket covering device for the burning lithium battery of the electric vehicle provided by the present invention is not limited to indoor application, and also can be applied to outdoor or related firefighting equipment, such as an outdoor parking lot (or parking space 40) or a fire engine. If the automatic fire blanket covering device for the burning lithium battery of the electric vehicle is applied to the fire engine (such as a ladder truck), the automatic fire blanket covering device for the burning lithium battery of the electric vehicle can be arranged on a suspended magazine of the ladder truck. By the suspended magazine, firefighters can be prevented from getting too close to a fire source, such as a burning vehicle. Although an electric vehicle is taken as an example in this embodiment, as long as it is a vehicle, such as an automobile, a diesel vehicle, a hybrid electric vehicle, a hydrogen energy vehicle and an energy battery vehicle, it can be suitable for the automatic fire blanket covering device for the burning lithium battery of the electric vehicle.

The sensor 13 can be arranged at an appropriate position of an indoor parking lot (or a parking space 40) or adjacent to the fire blanket box 10. An external power supply is electrically connected to the control unit or the socket 102 so as to provide electric energy to the fire blanket box 10. Or an internal power supply (such as a storage battery) of the automatic fire blanket covering device for the burning lithium battery of the electric vehicle provided by the present invention can provide electric energy to the fire blanket box 10.

If the sensor 13 senses that the electric vehicle 30 located below the fire blanket box 10 is on fire, such as a lithium battery fire, the control unit provides a start signal to the driving device, and the driving device drives the first door panel 100 and the second door panel 101 so as to strut the first door panel 100 and the second door panel 101.

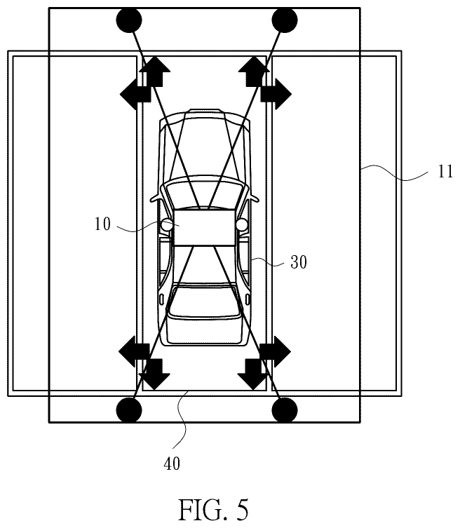

Referring to FIG. 5, FIG. 5 is a schematic diagram of a fire blanket of the present invention covering an electric vehicle. As shown in the figure, the control unit provides an ejection signal to the pneumatic device 12, and the pneumatic device 12 ejects four corners of the fire blanket 11 to four corners of the electric vehicle. Furthermore, the pneumatic device 12 ejects the four corners of the fire blanket 11 to four corners of the parking space 40 where the electric vehicle is parked.

The fire blanket 11 ejected from the fire blanket box 10 changes from a folded state to an unfolded state and covers the electric vehicle, and the vehicle system of the electric vehicle 30 is coated with the fire blanket 11, thereby blocking the interaction between the outside air and the burning electric vehicle 30 and achieving a fire extinguishing effect.

When the sensor 13 senses that the electric vehicle located below the fire blanket box 10, the caution light 104 can flash or change the color of the light so as to inform that there is an electric vehicle on fire around. The fire blanket box 10 can further include a voice device (not shown in the figure), and the voice device is in signal connection with the control unit. When the caution light 104 can flash or change the color of the light, the voice device informs that there is an electric vehicle on fire around by buzzing or voice.

In one embodiment, after a cabin door (the first door panel 100 and the second door panel 101 are strutted outward) of the fire blanket box 10 is opened and before the pneumatic device 12 acts, there will be the characteristic of safety warning. For example, after the sensing or the upper system (remote control or warming mechanism) is triggered, there will be a light signal (caution light 104) and voice warning for a period of time, the cabin door is opened (the fire blanket 11 is about to be thrown and ejected). After the cabin door is opened for a period of time, the light signal and the voice warning will still remain for a period of time so as to inform that the fire blanket 11 is about to be thrown and ejected.

In conclusion, the automatic fire blanket covering device for the burning lithium battery of the electric vehicle provided by the present invention can be arranged on a ceiling inside the building (the indoor parking lot or the parking space 40), and is located above the electric vehicle. When the sensor 13 senses that the electric vehicle 30 located below the automatic fire blanket covering device for the burning lithium battery of the electric vehicle is on fire, such as smoke, fire and sudden temperature rise, the control unit starts the pneumatic device 12, so that the fire blanket 11 is ejected towards the four corners of the parking space 40 where the electric vehicle 30 is parked or the four corners of the vehicle body of the electric vehicle, thereby covering the electric vehicle 30 and achieving a fire extinguishing effect.

The automatic fire blanket covering device for the burning lithium battery of the electric vehicle provided by the present invention has the advantages of mounting simply and conveniently and considering the requirements of site mounting and subsequent maintenance; the automatic fire blanket covering device for the burning lithium battery of the electric vehicle provided by the present invention is simple in periodic maintenance and convenient in replacement of consumables; the automatic fire blanket covering device for the burning lithium battery of the electric vehicle provided by the present invention has extremely low requirement on power, and can adopt battery or storage battery operation during power failure (outage); the automatic fire blanket covering device for the burning lithium battery of the electric vehicle provided by the present invention is provided with double safety warning such as the light signal (caution light 104) and voice; the safe lock 103 of the present invention adopts mechanical design so as to improve the use safety; the system of the present invention is simple and stable in structure, so maintenance is easy; the automatic fire blanket covering device for the burning lithium battery of the electric vehicle provided by the present invention is small in mounting height limitation and flexibly suitable for various fields; and the automatic fire blanket covering device for the burning lithium battery of the electric vehicle provided by the present invention acts rapidly, has extremely short covering time, and can effectively improve the efficiency.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An automatic fire blanket covering device for a burning lithium battery of an electric vehicle, comprising:
a fire blanket box, comprising a fire blanket magazine and further comprising a control unit;
a fire blanket, arranged on the fire blanket magazine; and
at least one pneumatic device, arranged on the fire blanket box and coupled to four corners of the fire blanket, the pneumatic device being in signal connection with the control unit.

2. The automatic fire blanket covering device for a burning lithium battery of an electric vehicle according to claim 1, wherein the fire blanket box includes a first door panel, a second door panel and a bottom plate; the first door panel is pivoted to one side of the fire blanket box;
the second door panel is pivoted to the other side of the fire blanket box; and the bottom plate is slidingly arranged at the bottom end of the fire blanket box, and the fire blanket covers the bottom plate.

3. The automatic fire blanket covering device for a burning lithium battery of an electric vehicle according to claim 2, further comprising at least one driving device, wherein the driving device is arranged on the fire blanket box and is in signal connection with the control unit, and the driving device is coupled to the first door panel and the second door panel.

4. The automatic fire blanket covering device for a burning lithium battery of an electric vehicle according to claim 1, wherein the fire blanket box further comprises a switch, a socket, a safe lock and a caution light, and the control unit is in signal connection with the switch, the socket, the safe lock and the caution light.

5. The automatic fire blanket covering device for a burning lithium battery of an electric vehicle according to claim 1, wherein one side of the fire blanket located outside the fire blanket box has a pattern.

6. The automatic fire blanket covering device for a burning lithium battery of an electric vehicle according to claim 1, further comprising at least one sensor, wherein the sensor is in signal connection with the control unit.

7. The automatic fire blanket covering device for a burning lithium battery of an electric vehicle according to claim 6, wherein the sensor is a smoke detector, an image detection device or a thermal imaging sensing device.

8. The automatic fire blanket covering device for a burning lithium battery of an electric vehicle according to claim 1, wherein the fire blanket box comprises a plurality of fixed strips and a plurality of dampers; the fixed strips are arranged at the corners of the fire blanket box; and the dampers are arranged at free ends of the fixed strips.
